(19) United States
(12) Patent Application Publication
(10) Pub. No.: US 2013/0220274 A1
(43) Pub. Date: Aug. 29, 2013

(54) CONTROL SYSTEM FOR DUAL FUEL ENGINES

(71) Applicants: Pralhad S. Deshpande, Pune (IN); Vilas V. Chinchankar, Pune (IN); Pravin A. Suryawanshi, Pune (IN)

(72) Inventors: Pralhad S. Deshpande, Pune (IN); Vilas V. Chinchankar, Pune (IN); Pravin A. Suryawanshi, Pune (IN)

(73) Assignee: CUMMINS INTELLECTUAL PROPERTY, INC., Minneapolis, MN (US)

(21) Appl. No.: 13/642,946

(22) PCT Filed: May 26, 2011
(86) PCT No.: PCT/US11/38153

§ 371 Date: Jan. 2, 2013

(30) Foreign Application Priority Data
Jun. 1, 2010 (IN) 1677/MUM/2010

(51) Int. Cl. F02D 41/38

(52) U.S. Cl. CPC F02D 41/38
USPC 123/350

(57) ABSTRACT

A control system for operation of a dual fuel engine is disclosed wherein the engine is operated by a liquid fuel and a gaseous fuel at varying loads and engine speeds. The control system has a first sensor and a second sensor for sensing intake manifold pressures of the engine and pressures of the liquid fuel respectively. A speed sensing means is provided to generate signals corresponding to engine speeds and varying loads. A liquid fuel actuator and a gaseous fuel actuator are provided to induct the liquid fuel and the gaseous fuel into the engine respectively.

### TECHNICAL FIELD

The present disclosure relates to the field of control systems for engines. In particular, the present disclosure relates to the field of control systems for dual fuel engines.

### BACKGROUND

In diesel-electric multiple units (DEMU), a diesel engine drives an electrical generator which produces electrical energy. A dual fuel engine is an engine integrated with an additional system allowing utilization of gaseous fuel, typically natural gas, as a supplemental fuel by using a certain level of liquid fuel (Pilot Fuel) for operation and for ignition of the gaseous fuel. The generated power is then fed to electric traction motors for driving wheels of a locomotive. The Diesel Electric Multiple Units (DEMU), typically operate in eight notches (steps). Every notch is characterized by a pre-determined speed and load. Hence the governor of the locomotive needs to control both the engine speed and the generator load. For diesel operation, the engine control is entirely achieved with the Diesel Actuator and is therefore a simple control. However, for dual fuel operation, a control strategy for introducing gas with proper control and limiting diesel needs to be developed. The dual fuel engine has a number of quality attributes. A primary benefit of using dual fuel engine is that it provides fuel flexibility, cleaner operation, use of cheaper natural gas when available and can operate on liquid fuel alone when necessary.

The presently available dual-fuel engine is integrated with a standard diesel engine. A measured quantity of natural gas is mixed with the air just before it enters the cylinder and compressed to the same levels as the diesel engine to maintain efficiency. The natural gas mixture does not ignite spontaneously under compression. Hence a small amount of diesel fuel is injected. The amount of diesel fuel injected acts like a multitude of microscopic spark-plugs, setting off clean and efficient combustion of the lean gas-air mixture.

Thus, there was felt a need for a control system that enables overcoming of the drawbacks of dual fuel engines known in the art.

### SUMMARY

This disclosure provides a method of optimized fuel induction at a particular revolution per minute (RPM) of an engine for dual fuel operation in an engine adapted to be operated using a liquid fuel and a gaseous fuel at varying loads and engine speeds, the method comprising: inducting the gaseous fuel and the liquid fuel into the engine commencing from a predetermined lower engine load limit; increasing an amount of gaseous fuel inducted into the engine as the engine load increases from the predetermined lower engine load limit to a predetermined upper engine load limit; limiting an increase in the amount of gaseous fuel inducted into the engine at engine load levels above the predetermined upper engine load limit; and increasing the amount of liquid fuel inducted by a predetermined quantity at engine load levels above said predetermined upper engine load limit.

Typically, in accordance with the present disclosure, the method of optimized fuel induction comprising:
identifying intake manifold pressures corresponding to a series of pre-determined load conditions;
identifying pressures of the liquid fuel corresponding to the series of pre-determined load conditions;
changing the pressures of the liquid fuel corresponding to a change in the intake manifold pressures and corresponding engine speeds; and
inducting fuel in a mode selected from a group of modes consisting of:
   a first mode wherein only liquid fuel is inducted into the engine;
   a second mode wherein induction of liquid fuel is maintained constant and the gaseous fuel is increasingly inducted corresponding to load; and
   a third mode wherein above a predetermined load, induction of the liquid fuel is boosted by a predetermined quantity and induction of gaseous fuel remains within specified limits.

Typically, in accordance with the present disclosure, the predetermined lower limit is in the range of 20 to 25% load.

Typically, in accordance with the present disclosure, the method of optimized fuel induction further comprising actuating a liquid fuel actuator and maintaining a gaseous fuel actuator in a closed position prior to the predetermined lower limit.

Preferably, in accordance with this disclosure, co-feeding gaseous fuel further comprises controlling a liquid fuel actuator to induct controlled liquid fuel and controlling a gaseous fuel actuator to induct gaseous increasingly.

Typically, in accordance with the present disclosure, the method of optimized fuel induction further comprises actuating a liquid fuel actuator for boosting the liquid fuel induction by a pre-determined quantity beyond the predetermined upper limit and maintaining the gaseous fuel actuator within a maximum specified limit.

In accordance with the present disclosure, there is provided a control system for optimized fuel induction for dual fuel operation in an engine adapted to be operated by a liquid fuel and a gaseous fuel at varying loads and engine speeds,

the system comprising:
a first sensor adapted to sense intake manifold pressures of the engine;
a second sensor adapted to sense pressures of the liquid fuel;
speed sensing means adapted to generate signals corresponding to engine speeds and varying loads;
a liquid fuel actuator adapted to induct the liquid fuel;
a gaseous fuel actuator adapted to induct the gaseous fuel; and
processing means adapted to receive signals from the first sensor, the second sensor and the speed sensing means and further adapted to generate at least one trigger signal selected from the group consisting of a trigger signal operating the liquid fuel actuator, a trigger signal operating the gaseous fuel actuator and a trigger signal operating the liquid fuel actuator and the gaseous fuel actuator.

### BRIEF DESCRIPTION OF ACCOMPANYING DRAWINGS

The system and method of the present disclosure will now be explained in relation to the accompanying drawings, in which:

FIG. 1 illustrates a block diagram of a control system for dual fuel engines known in the art;

FIG. 2 illustrates a block diagram of control requirements for dual fuel engines;

FIG. 3 illustrates a schematic flow diagram of an air-gas induction system of the control system for dual fuel engines in accordance with the present disclosure;

FIG. 4 illustrates a control architecture of the control system for dual fuel engines in accordance with the present disclosure;

FIG. 5 illustrates a graphical representation of the energy from Diesel and Gas (in BTU/min) versus load in percentage;

FIG. 6 illustrates a graphical representation of the control system for dual fuel engines implemented using open loop optimization;

FIG. 7 illustrates a schematic representation of a substitution logic of the control system for dual fuel engines implemented using closed loop optimization;

FIG. 8 illustrates a flow diagram of a substitution logic of the control system for dual fuel engines in accordance with the present disclosure;

FIG. 9 illustrates the substitution in percentage versus the notch number in the control system for dual fuel engines implemented using closed loop optimization;

FIG. 10 illustrates a graphical representation of the substitution error in percentage versus the notch number in the control system for dual fuel engines implemented using closed loop optimization; and

FIG. 11 illustrates the substitution error found on actual operation of the engine at full load for verification of the results obtained in FIG. 10.

### DETAILED DESCRIPTION OF ACCOMPANYING DRAWINGS

Control systems for dual fuel engines using field retrofit kits consisting of Programmable Logic Controller (PLC) and gas valves are known in the art. However, Applicant has recognized that the presently available dual fuel engines, including those using retrofit kits, are not capable of providing precise control for injection of diesel and gas under all operating conditions often resulting in emission problems.

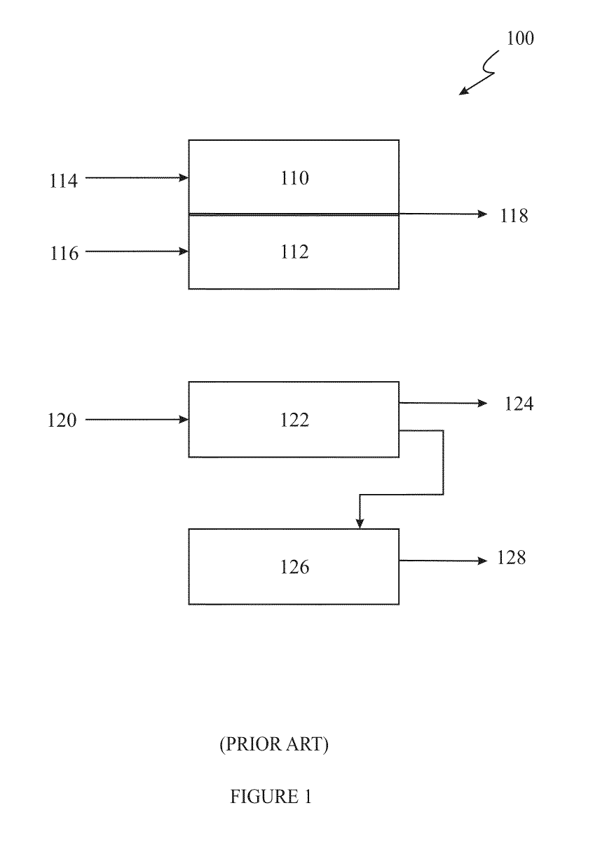

FIG. 1 illustrates a block diagram of a control system for dual fuel engines known in the art and is indicated generally by the numeral 100. The main steps/features involved in the control of the dual fuel engine are indicated generally as given below:
Speed Signal input (114);
Speed Control during Diesel mode (110);
Fuel Pressure input (116);
Substitution Control during dual fuel mode (112);
Actuator current output for Diesel Actuator Control (118);
Programmable Logic Controller (PLC) for Gas valve control (122);
Diesel Actuator Current input (120) to the PLC (122);
Adjusted actuated current (124) for the gas valve;
Excitation control (126) of the Generator; and
Excitation current (128) for Generator load control.

The control of substitution of fuel with gas is indirect in the known prior art system 100. When dual fuel operation is initiated, the PLC gradually opens the Gas Actuator thereby inducting gas into the intake air stream. This reduces the diesel requirement. Gas is admitted until the diesel fuel pressure reduces to a desired value. Closed loop Speed control is achieved using a Diesel Actuator. During transient conditions, the Diesel Actuator takes over since the response of Diesel is faster, thus leading to over fueling, until stable operation with Gas Actuator is achieved.

Furthermore, the load feedback in the system 100 is also indirect. The excitation logic takes load feedback based on Diesel Actuator current. Gas substitution reduces the Diesel Actuator current and needs to be manipulated for load feedback requirement. This impacts the stability and accuracy of the excitation control of the generator.

Thus engine operation using control systems as illustrated in FIG. 1 is unstable resulting in knocking, black smoke, high exhaust temperatures and afterburning in exhaust pipes; inadequate control and improper substitution, being the main reasons for unstable engine operation.

Several attempts have been made to provide reliable control systems for dual fuel engines. For instance, U.S. Pat. No. 6,543,395 discloses a bi-fuel control system for diesel engines and employs indirect control of the substitution of gas resulting in drawbacks explained herein above. It also involves complex calculations to decide the amount of gas for opening the gas valve precisely. Furthermore, U.S. Pat. No. 6,101,986 discloses a method for a controlled transition between operating modes of a dual fuel engine, wherein complex energy calculations are involved to decide the amount of fuel and gas to be delivered. Therefore, the aforesaid attempts towards providing a stable and reliable control system for dual fuel engines lack simplicity besides being unable to provide adequate control of the substitution needs of a dual fuel engine.

Therefore, in accordance with the present disclosure, a control system for dual fuel engines is envisaged that provides the following functions:
fuel flexibility;
precise control of diesel and Gas Actuator under all operating conditions;
optimized emission;
optimized efficiency;
high reliability;
safe and stable combustion;
a simple and ingenious design;
ample safety margins;
low maintenance;
built in electronic safety protection; and
eliminate unnecessary load reduction and shutdowns.

Dual fuel engines with a control system in accordance with the present disclosure provide closed loop control for limiting the quantity of diesel fuel consumed during the dual fuel operation. Initially, up to about 25% load, the engine operation is based on liquid fuel only and then dual fuel operation starts and gaseous fuel is inducted along with the liquid fuel. The speed control is transferred to a Gas Actuator in the dual fuel mode. Above a certain load, gaseous fuel cannot be increased, hence the amount of liquid fuel is increased, still limiting it in the closed loop. The liquid fuel used is typically diesel while the gaseous fuel used is natural gas.

The present disclosure will now be described with reference to an exemplary embodiment shown in the accompanying drawings. The embodiment does not limit the scope and ambit of the inventions. The description relates purely to the exemplary preferred embodiment and its suggested applications.

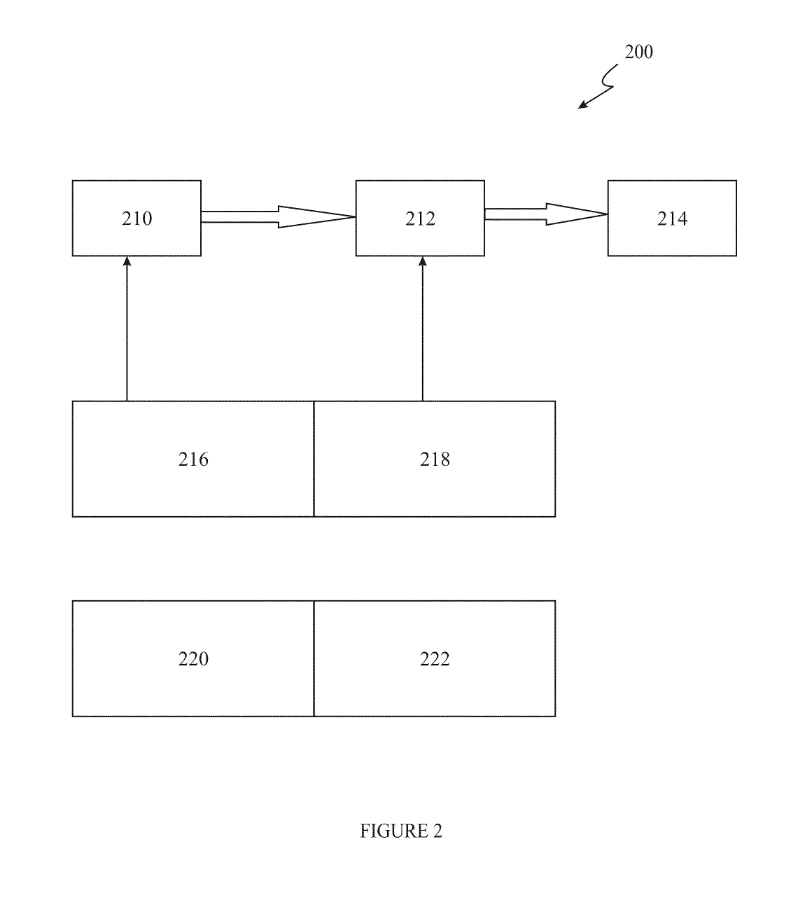

FIG. 2 illustrates a block diagram of control requirements for dual fuel engines and is generally indicated by the numeral (200).A Diesel Electric Multiple Unit (DEMU) Power train mainly comprises an engine (210), a generator (212) and traction motors (214), wherein the engine (210) generates mechanical energy for driving the generator (212) which in turn generates electrical energy that powers the traction motors (214) for driving the wheels of the locomotive.

A typical locomotive operates in 8 notches (steps). Every notch is characterized by a pre-determined speed and load. Hence, the governor of the locomotive needs to control both the engine speed and the generator load. For liquid fuel mode operation, the speed control of the engine (210) is entirely handled by a liquid fuel actuator and hence is a simple control. Speed control during liquid fuel mode of operation is represented by a block (216) and involves control of the fuel Actuator using speed as an input for the control logic. Block (218) represents Load KW control during liquid fuel mode of operation and involves control of the excitation of the generator (212) using load as an input for the control logic. For dual fuel operation, the control strategy for introducing gas and limiting liquid fuel is complex and needs to be optimized. Block (220) represents speed control during dual fuel operation and involves liquid fuel control, substitution control and Gas Actuator control using speed as an input for the control logic. Block (222) represents Load KW control (using Potential Transformer/Current Transformer modules for KW feedback) during dual fuel operation and involves control of the excitation of the generator (212) using load as an input for the control logic.

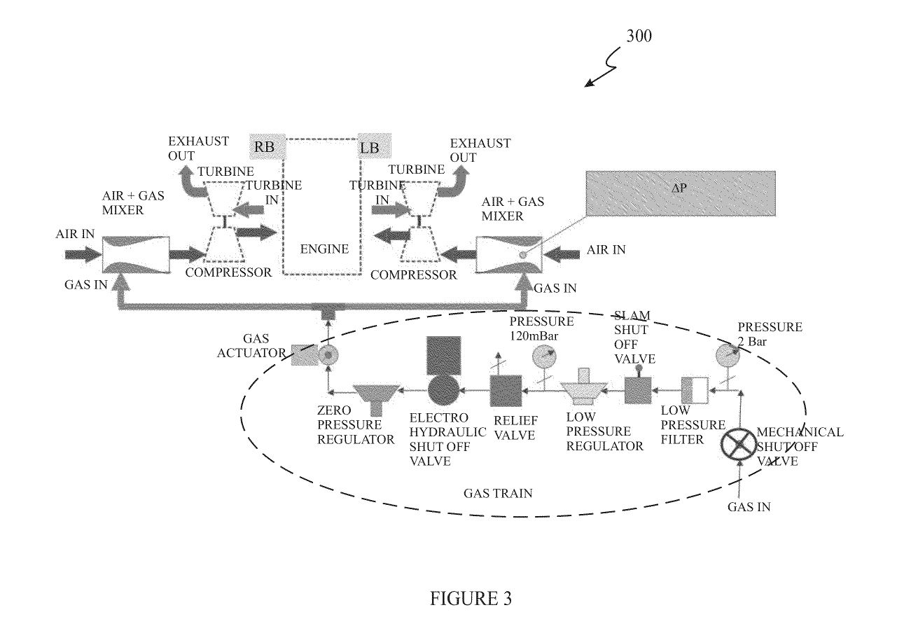

FIG. 3 illustrates a schematic flow diagram of an air-gas induction system of the control system for dual fuel engines in accordance with the present disclosure. A gaseous fuel is inducted in to the engine via a gas actuator. The gas actuator receives the gaseous fuel from a gas train via a zero pressure regulator. The zero pressure regulator enables induction of the gaseous fuel into the engine on sensing a predetermined pressure differential at the intake manifold. The dual fuel engine is operated in a liquid fuel mode wherein only a liquid fuel is inducted into the engine and a dual fuel mode wherein a gaseous fuel is inducted along with the liquid fuel.

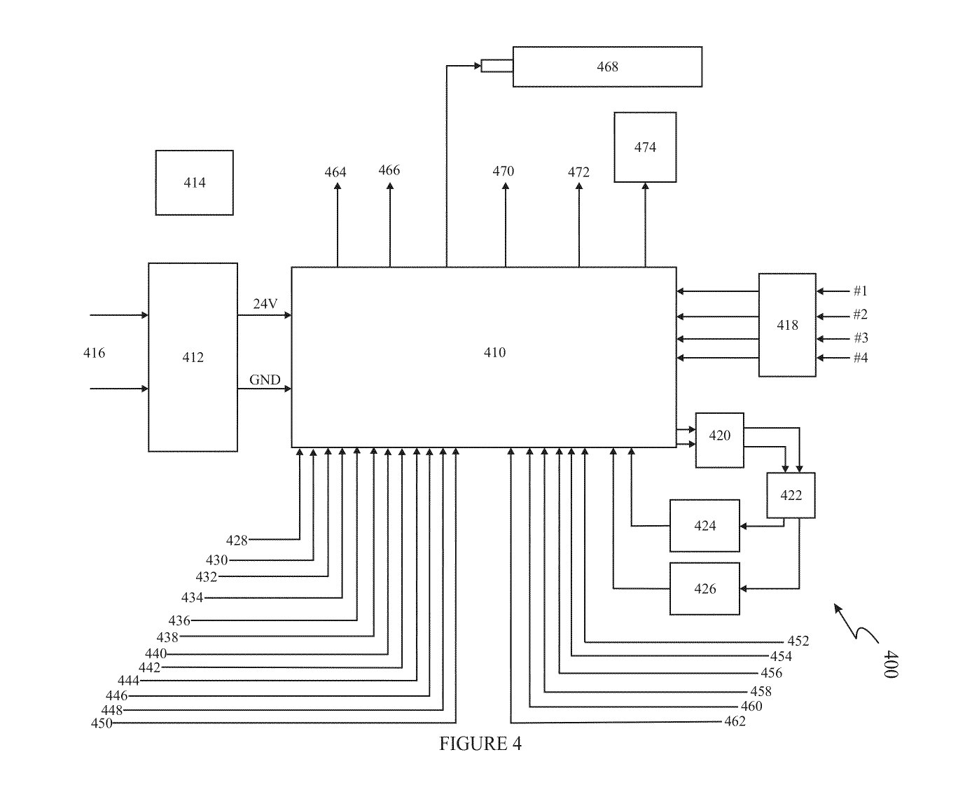

FIG. 4 illustrates a control architecture of the control system for dual fuel engines in accordance with the present disclosure. A governor (410) is provided for controlling the operation of the liquid fuel actuator (468), the gas actuator (474), excitation system and the engine safety panel. The governor (410) is provided with a power supply (412) that is isolated from the power supplied by the batteries (416) in order to avoid problems related to noise and voltage spikes. The governor (410) cooperates with a plurality of sensors to receive analog and digital inputs pertaining to several parameters. A tachometer (428) is provided to measure and transmit the speed of operation of the engine to the governor (410). A sensor (430) is provided for measuring the pressure of the liquid fuel in a fuel rail (not shown in figure) to provide Fuel Rail Pressures. A Gas Pressure Switch (432) is provided to sense pressure of the gaseous fuel for dual fuel operation. The Gas Pressure Switch (432) automatically switches over to liquid fuel mode without intervention of the operator in the absence of the gaseous fuel in the dual fuel mode of the engine. A Gas Throttle Position sensor (434) is provided to sense the percentage opening of the gas actuator (474). At least one Exhaust Temperature Sensor (436 and/or 438) is provided to sense the temperature of the exhaust gases so as to enable operation of the engine within predetermined thermal boundaries. The Exhaust Temperature Sensor (436 and/or 438) is typically a thermistor based exhaust gas temperature sensor. A Vibration sensor (440) is provided for measuring, displaying and analyzing linear velocity, displacement, proximity and acceleration of the vehicle. At least one Intake Manifold Pressure sensor (442 and/or 444) enables sensing of intake manifold pressure which indicates the load necessary for kW Load demand and engine overload protection, at least one Intake Manifold Temperature sensor (458 and/or 460) for providing engine protection in dual fuel mode, Coolant Temperature Sensor (450) and a Coolant Pressure Sensor (448) is provided for engine protection and engine warm-up before starting of the dual fuel operation. A Lube Oil Pressure sensor (446) and a Lube Oil Temperature sensor (462) are provided for protection of the engine. An Emergency Switch (456) is provided to de-actuate the liquid fuel actuator and gas actuator power in case of an emergency. Ignition Switch (452) enables providing a starting signal to the governor (410) and a Dual Fuel Switch (454) is provided for dual fuel operation. A Potential Transformer Sensor (424) is provided to sense traction generator output voltage while a Current Transformer Sensor (426) is provided to sense traction generator output current. The Potential Transformer Sensor (424) and the Current Transformer Sensor (426) are required to calculate the load on the engine. A Relay Module (418) is provided to sense notch position and transmit the same to the governor (410).

The governor (410) provides an output signal to a liquid fuel actuator (468), a gas actuator (474), a gas solenoid valve (472), a liquid fuel solenoid valve (470), a fault code lamp (464) and an excitation hardware module (420). The liquid fuel actuator (468) and the gas actuator (474) enable controlling the speed of operation of the engine in the liquid fuel mode and the dual fuel mode respectively. The liquid fuel shutoff valve (470) enables in turning off the engine while the gas shutoff valve (472) enables turning off the supply of gas in case of emergency. The liquid fuel shutoff valve (470) and the gas shutoff valve (472) are typically solenoid valves. The fault code lamp (464) enables providing indication of any operation fault or any fault in the sensors. The excitation hardware module (420) enables amplifying the 24 volts power supply to the governor (410) from the battery (416) to 110 volts DC. The amplified power of 110 volts is supplied to field windings of a traction generator (422) to produce a voltage and current through the potential transformer (424) and the current transformer (426).

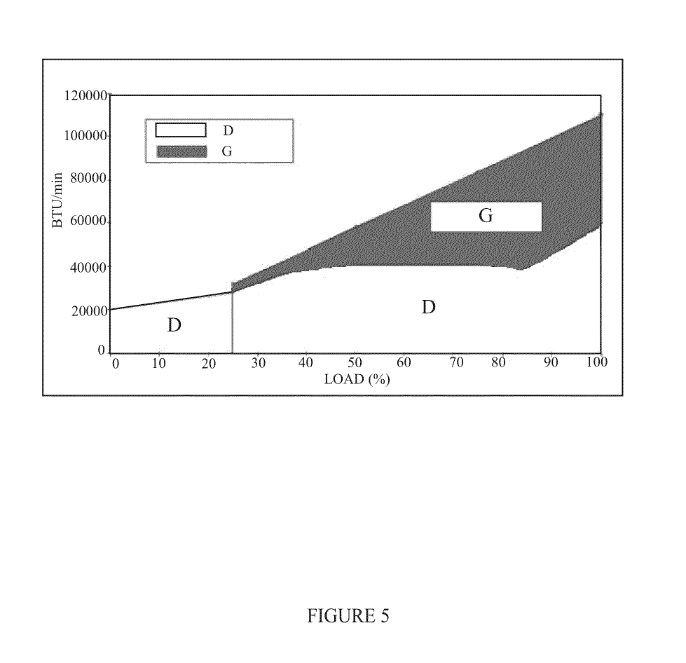

FIG. 5 illustrates the energy in BTU/min obtained from liquid fuel and the gaseous fuel versus load in percentage at a particular notch. The gaseous fuel is not inducted into the engine till the load is in the range of 20% to 25% of the load at a particular RPM. The energy obtained from combustion of the liquid fuel is represented by D while the energy obtained from combustion of the gaseous fuel is indicated by G.

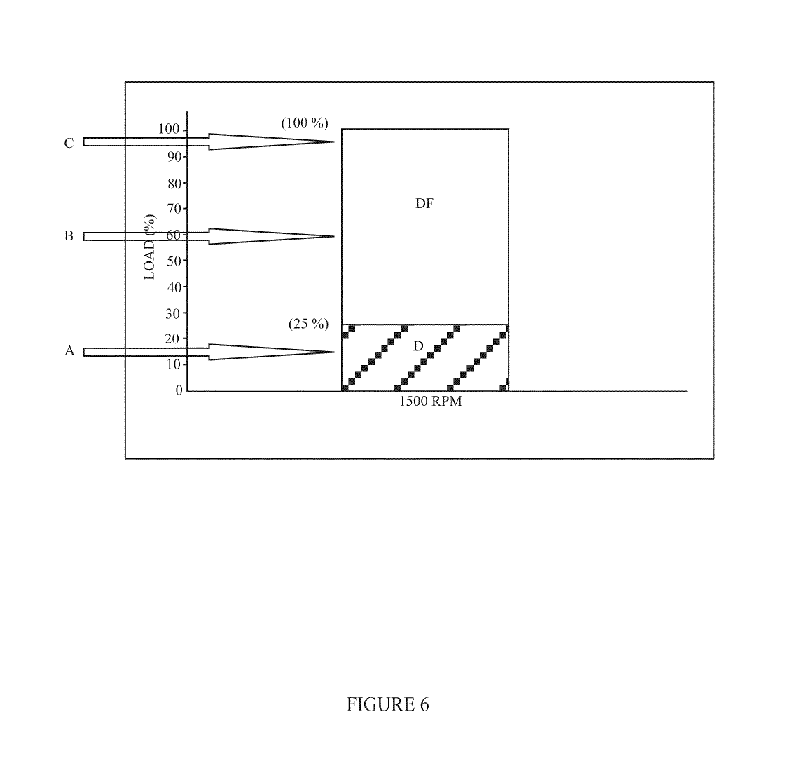

FIG. 6 illustrates a graphical representation of the control system for dual fuel engines implemented using open loop optimization. The liquid fuel operating region of the engine is represented as D and the dual fuel operation of the engine is represented by DF. The control architecture of the control system for dual fuel engines, shown in FIG. 4 is first operated in an open loop and then in a closed loop. The operation of the dual fuel engine is carried out in an open loop for calculating the amount of fuel to be inducted by taking into consideration the input signals received by the governor (410). The operation of the dual fuel engine is carried out in the closed loop by calculating the amount of fuel to be inducted by taking into consideration input sensors and feedbacks on predetermined parameters. An optimization of the performance is carried out in liquid fuel mode and in dual fuel mode using dual fuel engines having control requirements (200) shown in FIG. 2. In the liquid fuel mode of operation, the base line performance of the dual fuel engine for a plurality of parameters is recorded at different revolutions per minute (RPM). The parameters recorded during the optimization of the performance in the liquid fuel mode are temperature, pressure, flow, peak cylinder pressure and exhaust emissions.

The open loop performance of the dual fuel engine in the dual fuel mode is carried out by firstly determining a lower limit below which only the liquid fuel is inducted in to the engine, represented by D in FIG. 6; since the air fuel ratio is very lean, that is, beyond the lean flammability limits for burning of the gaseous fuel. Hence, when gaseous fuel is inducted below the lower limit, at point A of FIG. 6, there is no increase in power of the engine and it also results in an increase in total hydrocarbon (THC) exhaust emissions from the engine. The lower limit is optimized in the range of 20% to 25% of the load at a particular RPM. The lower limit is required to be optimized in order to avoid misfire, exhaust afterburning as well to maximize liquid fuel substitution by the gaseous fuel. Secondly, above the lower limit and upto a predetermined upper limit, represented as B, the liquid fuel induction is limited to a pre-determined value and the induction of the gaseous fuel is initiated by actuation of the gaseous fuel actuator (474). Thus, beyond the lower limit, the engine is operated on dual fuel mode and is represent by DF in FIG. 6. The gaseous fuel actuator (474) responds to an increase in load beyond a predetermined lower limit. Thirdly, as the load at a predetermined RPM increases beyond the upper limit, represented by B, till the maximum predetermined load that is optimized to be attained at a particular RPM is attained, the quantity of liquid fuel is boosted by a predetermined quantity to prevent knocking, higher thermal/mechanical loading on the engine. The point at which the induction of liquid fuel is boosted is represented by C.

In the dual fuel mode, represented by DF, the maximum amount of liquid fuel and the maximum amount of gaseous fuel to be inducted is determined by considering the thermal limits of the engine namely Turbine Inlet Temperature (TIT), Turbine Outlet Temperature (TOT) and Peak combustion Temperature, Mechanical limits namely Peak Cylinder Pressure, Knock Margin and Exhaust Emissions namely NOx, THC, CO and Smoke.

The open loop optimization logic provides the following values that are then used in the closed loop substitution logic in order to overcome the performance issues that were noticed:
1. Intake manifold pressure values for desired load condition; and
2. Liquid fuel, fuel pressure values for identified substitutions.

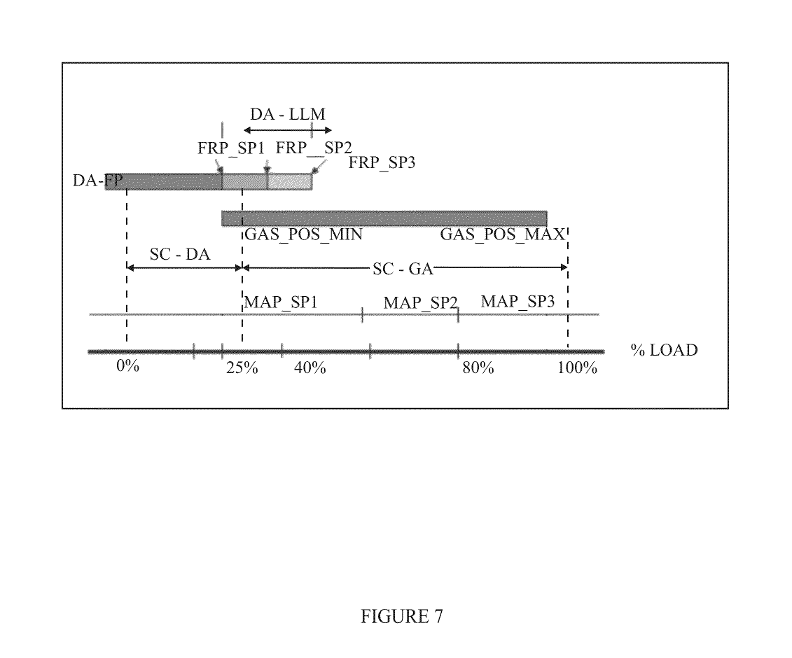

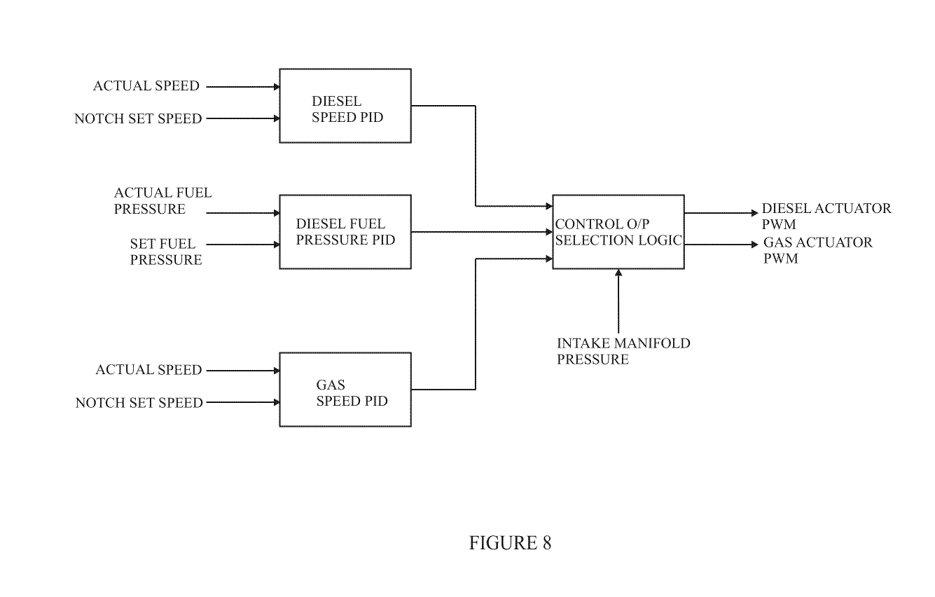

The optimization of the lower limit and the upper limit is carried out by maintaining the total energy produced during dual fuel mode of operation of the engine equal to the total energy in obtained in the liquid fuel mode. During optimization of the lower limit and the upper limit, optimized values for fuel rail pressure, gaseous fuel throttle position, exhaust gas temperature and intake manifold temperature are recorded and are used as inputs to the substitution logic, shown in FIG. 7 and FIG. 8.

FIG. 7 illustrates a schematic representation of a substitution logic of the control system for dual fuel engines implemented using closed loop optimization, wherein SC-DA represents Speed Control of Liquid fuel actuator, DA-LLM represents Liquid fuel Actuator Load Limit Mode, DA-FP represents Liquid fuel Actuator Fuel Pressure and SC-GA represents Speed Control of Gaseous fuel Actuator.

Initially, the speed control is achieved with Liquid Actuator (468) PID (proportional-integral-derivative) control and the Gaseous fuel Actuator (474) is maintained in closed position.

When the lower limit is reached, as identified by manifold pressure MAP_SP1 and Liquid Fuel Pressure FRP_SP1, the speed control is transferred to the Gaseous fuel Actuator (474) PID control while the Liquid Actuator (468) is in the Load Limit mode DA-LLM by fuel pressure feedback and hence the induction of liquid fuel quantity is limited. This is a closed loop PID control with Fuel Rail Pressure as a feedback.

As the load further increases, which is identified by the intake manifold temperature and pressure, the Load limiting Set points for Liquid Fuel pressure DA-FP are incremented. For instance, at manifold pressure MAP_SP2, the fuel pressure DA-FP is increased to FRP_SP2 and similarly at MAP_SP3, the fuel pressure DA-FP is set to FRP_SP3. As the total energy produced during liquid fuel mode and dual fuel mode is required to be maintained constant at a predetermined load, the induction of the liquid fuel is boosted by a predetermined quantity so that amount of gaseous fuel induction does not exceed safe limits as determined by exhaust temperatures and knock levels.

The settable threshold parameters for achieving desired substitution and actions related to these thresholds are summarized as follows:

FRP_SP1: Fuel Rail Pressure limit for initial substation. Liquid Actuator (474) controls the engine speed up to this point. The Intake Manifold pressure at this point is MAP_SP1.

MAP_SP2: As the engine load increases and the Manifold pressure crosses MAP_SP2, the Fuel Rail Pressure is increased to FRP_SP2.

MAP_SP3: As the engine Manifold pressure crosses MAP_SP3, Fuel Rail pressure is increased to FRP_SP3.

GAS_POS_MAX: When Gaseous fuel Actuator (468) reaches this value for a particular RPM, the Gaseous fuel Actuator (468) is stopped from opening further.

FIG. 8 illustrates a flow diagram of the substitution logic of the control system for dual fuel engines shown in FIG. 7. The following criteria form the basis for the substitution logic:
1. Determination of a lower most point, below which gaseous fuel cannot be admitted based on the following:
   i. in dual fuel systems, at part loads, the air/fuel ratio is too lean (beyond flammability limits);
   ii. pilot liquid fuel combustion temperature is lower, which does not help for gaseous fuel to burn effectively;
   iii. the lower most point must be characterized by no increase in power, even when gaseous fuel is admitted;
   iv. total hydrocarbon (THC) exhaust emissions;
   v. avoid misfire, after burning of exhaust emissions and maximize liquid fuel substitution by natural gas; and
   vi. deliver same output whether the engine is running on fuel or gas.
2. Determination of maximum gaseous fuel induction at higher loads based on the following:
   i. thermal limits (TIT/TOT/Peak Combustion Temperature);
   ii. mechanical limits (Peak Cylinder Pressure);
   iii. knock margin (Knock free operation with good margins); and
   iv. exhaust emissions (NOx, THC, CO, Smoke)
3. Dual fuel optimization between lower and upper limits based on the following:
   i. Overall energy efficiency i.e. total energy in dual fuel mode must be equal to total energy in liquid fuel mode.

The substitution logic of the control system for dual fuel engines provides the following features:
direct control for both Liquid Fuel and Gaseous Fuel;
the control is always in closed loop with feedback of Speed or Fuel Pressure; and
all the control loops such as Actuator Speed, Liquid fuel Actuator Fuel Pressure and Gaseous fuel Actuator Speed are precise PID controls loops.

Thus, the Direct Multipoint Closed Loop Substitution Logic, shown in FIG. 8 of the control system for dual fuel engines provides the frame work for optimizing and providing a stable and precise control of Liquid fuel Actuator and Gaseous Actuator under all operating conditions. The Liquid fuel Actuator and the Gaseous Actuator are driven by Pulse Width Modulated (PWM) outputs from the control output selection logic.

Although the explanation provided herein above is with reference to a Diesel Electric Multiple Unit (DEMU), the control system for dual fuel engines in accordance with the present disclosure can be extended to other applications, for instance, gensets.

### TEST RESULTS

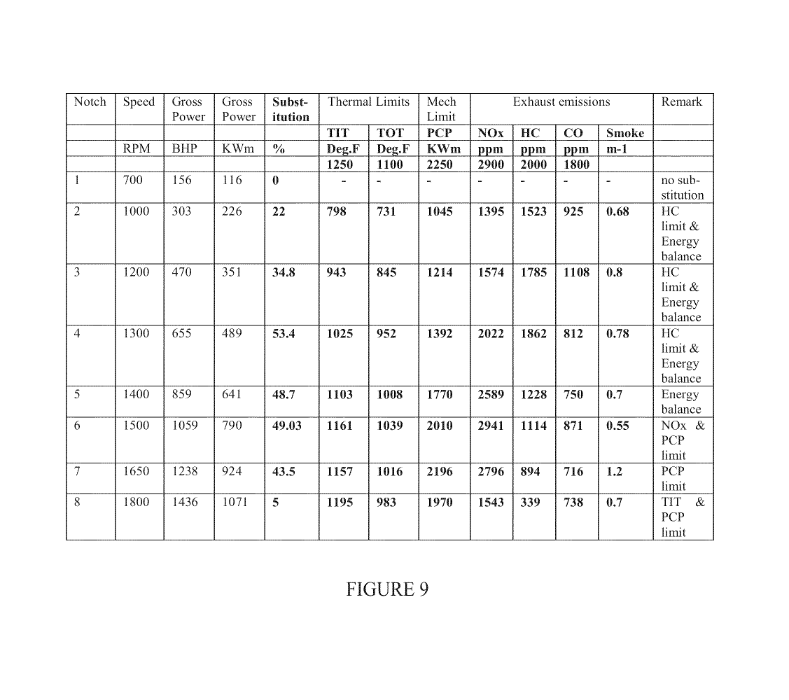

FIG. 9 illustrates the various parameters of the dual fuel engine. It has been observed that the power obtained during operation of the engine on liquid fuel only is the almost the same as that achieved in the dual fuel mode. Further, the thermal limits, the mechanical limits and the exhausted emissions are found to be within limits.

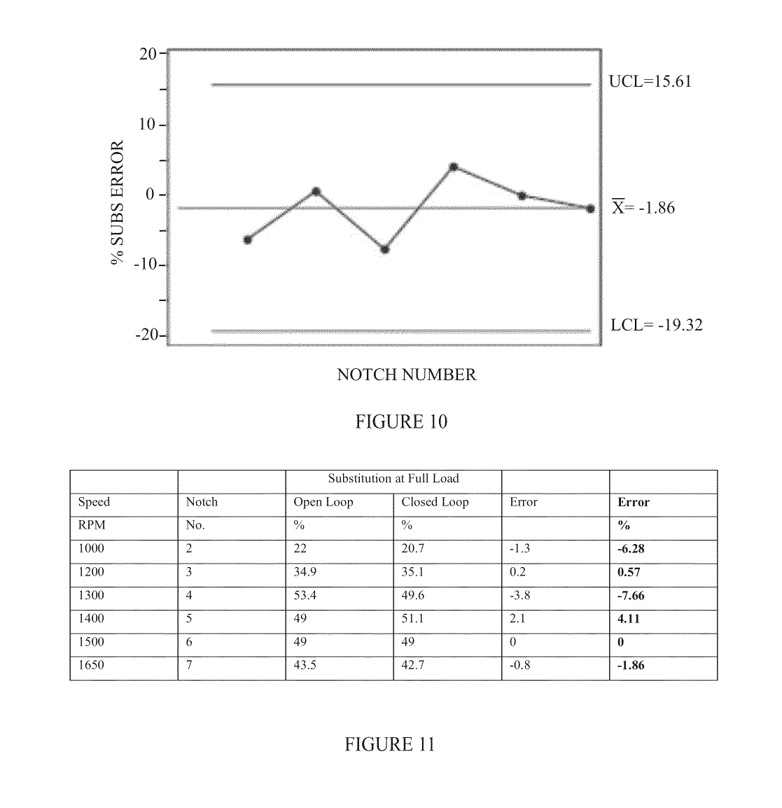

FIG. 10 illustrates a graphical representation of the substitution error in percentage versus the notch number in the control system for dual fuel engines implemented using closed loop optimization. FIG. 11 illustrates the substitution error found on operation of the engine at full load. It has been found that the substitution in the closed loop operation is within +/−8% of the open loop optimized value.

### TECHNICAL ADVANCEMENTS AND ECONOMIC SIGNIFICANCE

The technical advancements offered by the control system for dual fuel engines in accordance with the present disclosure which add to the economic significance include the realization of:
fuel flexibility;
precise control of liquid fuel Actuator and Gas Actuator under all operating conditions;
optimized emissions;
optimized efficiency;
high reliability;
safe and stable combustion;
a simple and ingenious design;
ample safety margins;
low maintenance;
built in electronic safety protection; and
eliminate unnecessary load reduction and shutdowns.

The numerical values given of various physical parameters, dimensions and quantities are only approximate values and it is envisaged that the values higher or lower than the numerical value assigned to the physical parameters, dimensions and quantities fall within the scope of the inventions and the claims unless there is a statement in the specification to the contrary.

Wherever a range of values is specified, a value up to 10% below and above the lowest and highest numerical value respectively, of the specified range, is included in the scope of the inventions.

While considerable emphasis has been placed herein on the specific features of the preferred embodiment, it will be appreciated that many additional features can be added and that many changes can be made in the preferred embodiment without departing from the principles of the inventions. These and other changes in the preferred embodiments will be apparent to those skilled in the art from the disclosure herein, whereby it is to be distinctly understood that the foregoing descriptive matter is to be interpreted merely as illustrative of the inventions and not as a limitation.

1. A method of optimized fuel induction at a particular revolution per minute (RPM) of an engine for dual fuel operation in an engine adapted to be operated using a liquid fuel and a gaseous fuel at varying loads and engine speeds, said method comprising: inducting the gaseous fuel and the liquid fuel into the engine commencing from a predetermined lower engine load limit; increasing an amount of gaseous fuel inducted into the engine as the engine load increases from the predetermined lower engine load limit to a predetermined upper engine load limit; limiting an increase in the amount of gaseous fuel inducted into the engine at engine load levels above said predetermined upper engine load limit; and increasing the amount of liquid fuel inducted by a predetermined quantity at engine load levels above said predetermined upper engine load limit.

2. The method as claimed in claim 1 comprising:
identifying intake manifold pressures corresponding to a series of pre-determined load conditions;
identifying pressures of the liquid fuel corresponding to said series of pre-determined load conditions;
changing said pressures of the liquid fuel corresponding to a change in said intake manifold pressures and corresponding engine speeds; and
inducting fuel in a mode selected from a group of modes consisting of:
a first mode wherein only liquid fuel is inducted into the engine;
a second mode wherein induction of liquid fuel is maintained constant and the gaseous fuel is increasingly inducted corresponding to load; and
a third mode wherein above a predetermined load, induction of the liquid fuel is boosted by a predetermined quantity and induction of gaseous fuel remains within specified limits.

3. The method as claimed in claim 1, wherein said predetermined lower limit is in the range of 20 to 25% load.

4. The method as claimed in claim 1 further comprising actuating a liquid fuel actuator and maintaining a gaseous fuel actuator in a closed position prior to said predetermined lower limit.

5. The method as claimed in claim 1, wherein co-feeding gaseous fuel further comprises controlling a liquid fuel actuator to induct controlled liquid fuel and controlling a gaseous fuel actuator to induct gaseous increasingly.

6. The method as claimed in claim 1 further comprising actuating a liquid fuel actuator for boosting the liquid fuel induction by a pre-determined quantity beyond said predetermined upper limit and maintaining the gaseous fuel actuator within a maximum specified limit.

7. A control system for optimized fuel induction for dual fuel operation in an engine adapted to be operated by a liquid fuel and a gaseous fuel at varying loads and engine speeds,
said system comprising:
a first sensor adapted to sense intake manifold pressures of said engine;
a second sensor adapted to sense pressures of the liquid fuel;
speed sensing means adapted to generate signals corresponding to engine speeds and varying loads;
a liquid fuel actuator adapted to induct the liquid fuel;
a gaseous fuel actuator adapted to induct the gaseous fuel; and
processing means adapted to receive signals from said first sensor, said second sensor and said speed sensing means and further adapted to generate at least one trigger signal selected from the group consisting of a trigger signal operating said liquid fuel actuator, a trigger signal operating said gaseous fuel actuator and a trigger signal operating said liquid fuel actuator and said gaseous fuel actuator.
